(19) United States
(12) Patent Application Publication
(10) Pub. No.: US 2010/0020008 A1
(43) Pub. Date: Jan. 28, 2010

(54) LIQUID CRYSTAL DISPLAY APPARATUS

(75) Inventors: Takahiro KOBAYASHI, Okayama (JP); Toshiki ONISHI, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Osaka (JP)

(21) Appl. No.: 12/509,799

(22) Filed: Jul. 27, 2009

(30) Foreign Application Priority Data
Jul. 28, 2008 (JP) 2008-194050

(51) Int. Cl. G09G 3/36

(52) U.S. Cl. 345/102

(57) ABSTRACT

In the case where the light source is a white LED backlight, a liquid crystal display apparatus can change the color temperature of a display image by performing a drive control of the light source. Liquid crystal panel 101 displays images. White LED backlight 102 has white LED's 106 and illuminates liquid crystal panel 101. White LED driving section 103 generates drive pulses for white LED's 106. Control data calculating section 104 controls the color temperature of white LED backlight 102 by increasing or decreasing values of current of the drive pulses that are generated. Control data calculating section 104 determines the duty cycles of the drive pulses that are generated, according to the values of current that are increased or decreased.

### CROSS REFERENCE TO RELATED APPLICATIONS

The disclosure of Japanese Patent Application No. 2008-194050, filed on Jul. 28, 2008, including the specification, drawings and abstract, is incorporated herein by reference in its entirety.

### TECHNICAL FIELD

The technical field relates to a liquid crystal display apparatus.

### BACKGROUND ART

There is one kind of liquid crystal display apparatus that illuminates a liquid crystal panel using an LED backlight formed by aligning light emitting diodes (LED's).

Generally, a liquid crystal panel has a characteristic of changing the transmittance according to the wavelength of light, due to the influence of the liquid crystal, polarizing plate, color filter and so on. Therefore, when the brightness level of an input image signal is low, there are cases where black color has a bluish tinge in the display image on a liquid crystal panel.

To solve this problem, some liquid crystal display apparatuses perform a color temperature control of display images.

For example, the conventional liquid crystal display apparatus disclosed in Patent Literature 1 controls the color temperature of an LED backlight according to the brightness level of an input image signal. To be more specific, when the brightness level of an input image signal lowers, for example, the brightness level of blue LED's that form the B light source decreases below the brightness levels of the light sources of other colors, so that black color with a bluish tinge in the display image is corrected.

### Citation List

### Patent Literature

PTL 1: Japanese Patent Application Laid-Open No. 2008-152008

### SUMMARY

### Technical Problem

The LED backlight controlled in the above conventional liquid crystal display apparatus employs a configuration including light sources of different colors. There are an LED backlight in which LED's of a plurality of colors (for example, three colors of R (red), G (green) and B (blue)) are aligned, and an LED backlight in which white LED's are aligned (i.e. white LED backlight). However, few proposals are made on an active basis as to how to control the color temperature in the case where use of a white LED backlight is assumed.

The object is to provide a liquid crystal display apparatus that, when the light source is a white LED backlight, can change the color temperature of a display image by performing a drive control of the light source.

### Solution to Problem

To achieve the above object, the liquid crystal display apparatus employs a configuration which includes: a liquid crystal panel that displays an image; a backlight that has a white light emitting diode and illuminates the liquid crystal panel; a generating section that generates a drive pulse for the white light emitting diode; and a controlling section that controls a color temperature of the backlight by increasing or decreasing a value of current of the drive pulse that is generated, and in which the controlling section determines a duty cycle of the drive pulse that is generated, according to the value of current that is increased or decreased.

Further, to achieve the above object, the liquid crystal display apparatus employs a configuration which includes: a liquid crystal panel that displays an image based on an image signal; a backlight that comprises a white light emitting diode and illuminates the liquid crystal panel; a generating section that generates a drive pulse for the white light emitting diode; a detecting section that detects one of the amount of characteristic of the image signal and the amount of characteristic of ambient light; and a controlling section that controls a color temperature of the backlight by increasing or decreasing a value of current of the drive pulse that is generated, according to the amount of characteristic detected.

### Advantageous Effects

A liquid crystal display apparatus according to the present invention can c hange the color temperature of a display image by performing a drive control of the light source in the case the light source is a white LED backlight.

### BRIEF DESCRIPTION OF DRAWINGS

FIG. 1 is a block diagram showing a configuration of a liquid crystal display apparatus according to Embodiment 1 of the present invention;

FIG. 2 shows alignment of white LED's in a white LED backlight according to Embodiment 1 of the present invention;

FIG. 3 shows an LED drive pulse according to Embodiment 1 of the present invention;

FIG. 4 is a flowchart showing the LED drive pulse control according to Embodiment 1 of the present invention;

FIG. 5 is a flowchart showing processing of determining the value of current and pulse width of an LED drive pulse according to Embodiment 1 of the present invention;

FIG. 6 shows an LED drive pulse according to Embodiment 1 of the present invention for which both the value of current and duty cycle are changed;

FIG. 7 is a chromaticity diagram showing the relationship between the forward current and chromaticity points in a white LED having a YAG fluorescent material;

FIG. 8 is a chromaticity diagram showing the relationship between the forward current and chromaticity points in a white LED having a silicate fluorescent material;

FIG. 9 is a chromaticity diagram showing the relationship between chromaticity points and input image signals in a liquid crystal panel;

FIG. 10 shows an LED drive pulse according to Embodiment 1 of the present invention for which only the value of current is changed; and

FIG. 11 is a block diagram showing a configuration of the liquid crystal display apparatus according to Embodiment 2 of the present invention.

### DESCRIPTION OF EMBODIMENTS

Hereinafter, embodiments of the present invention will be explained in detail using the accompanying drawings.

### Embodiment 1

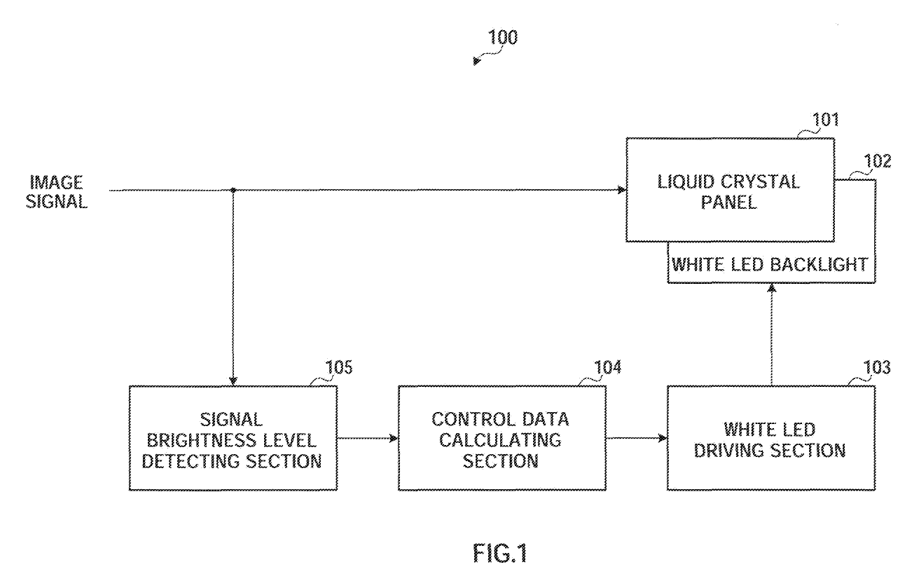

FIG. 1 is a block diagram showing a configuration of a liquid crystal display apparatus according to Embodiment 1 of the present invention.

Liquid crystal display apparatus 100 has liquid crystal panel 101, white LED backlight 102, white LED driving section 103, control data calculating section 104 and signal brightness level detecting section 105.

Liquid crystal panel 101 is a transmissive or semi-transmissive liquid crystal panel. Liquid crystal panel 101 allows light emitted from white LED backlight 102 to pass therethrough, and outputs this passing light from the front surface of the display screen. At this time, a liquid crystal driving section (not shown) controls the drive voltage that drives liquid crystal panel 101 based on an image signal, which is a digital signal representing an image to be displayed on the display screen of liquid crystal panel 101, and thereby controls the transmittance of liquid crystal panel 101. As a result of this control, liquid crystal panel 101 displays images.

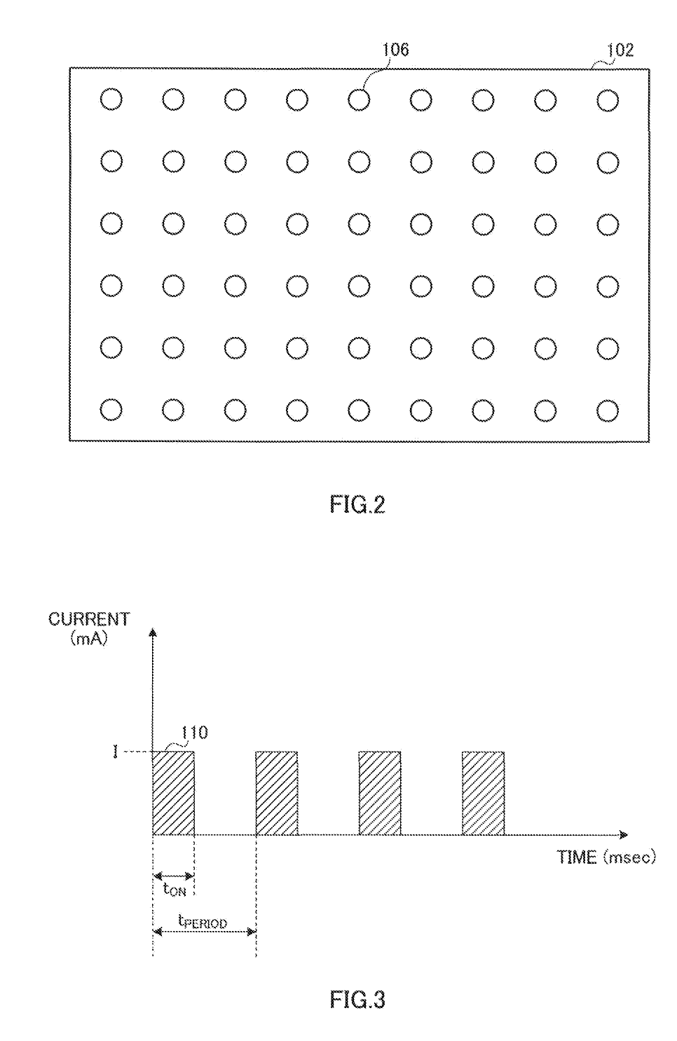

As shown in FIG. 2, white LED backlight 102 is a direct type backlight apparatus that has multiple white LED's 106 that are aligned virtually flat on the substrate and that are arranged facing with the back surface of liquid crystal panel 101. White LED backlight 102 is provided on the side of the back surface of liquid crystal panel 101 and illuminates liquid crystal panel 101 with white light emitted from white LED's 106.

By the way, white LED backlight 102 may be an edge light type backlight device.

White LED 106 is an LED unit having mainly a monochromatic (for example, blue) LED and a fluorescent material, and is driven by a drive pulse applied from white LED driving section 103 and emits white light. That is, white LED 106 is configured such that light that is emitted from a monochromatic LED when a drive pulse is applied, passes through the fluorescent material and is whitened through the action of the fluorescent material.

Further, of the present embodiment, although white LED 106 is an LED unit that employs a configuration including a monochromatic LED and fluorescent material and emits white light, white LED 106 may be an LED unit that employs other configurations and emits white light. Generally, an LED unit that employs configurations including LED's of different colors and emits white light by mixing lights emitted from these LED's, is generally able to control the drive of LED's per color-producing light. However, white LED 106 does not employ such a configuration.

Signal brightness level detecting section 105, which is a detecting section or a detector, is a circuit that detects the average brightness level (APL: Average Picture Level) as the amount of characteristic of an image signal.

Further, in addition to the average brightness level or instead of the average brightness level, signal brightness level detecting section 105 may detect the brightness levels such as the maximum brightness level (MAX) and the minimum brightness level (MIN) as the amount of characteristic. In this case, signal brightness level detecting section 105 may additionally detect the area or position of the portion in an image where the brightness level is maximized or minimized.

Control data calculating section 104, which is a controlling section or a controller, is a calculation processing circuit that calculates a value of current and duty cycle of a drive pulse for white LED 106 based on the amount of characteristic detected to control the color temperature of white LED backlight 102. Control data calculating section 104 generates control data representing the calculated value of current and duty cycle, and outputs the generated control data to white LED driving section 103.

White LED driving section 103, which is a generating section or a generator, is a circuit that generates drive pulses for driving white LED's 106 according to control data inputted from control data calculating section 104 and applies the generated drive pulses to white LED's 106.

FIG. 3 shows an example of a drive pulse that is generated. Drive pulse 110 shown in FIG. 3 is a rectangular pulse of a duty cycle D((%)=pulse width t_{ON}/pulse period t_{PERIOD}) and value of current I.

This is the configuration of liquid crystal display apparatus 100.

Next, the operation of an LED drive pulse control in liquid crystal display apparatus 100 will be explained. Here, a case will be explained as an example where the average brightness level of an image signal is the amount of characteristic to be detected and drive pulse 110 shown in FIG. 3 is the drive pulse for white LED's 106 to be controlled.

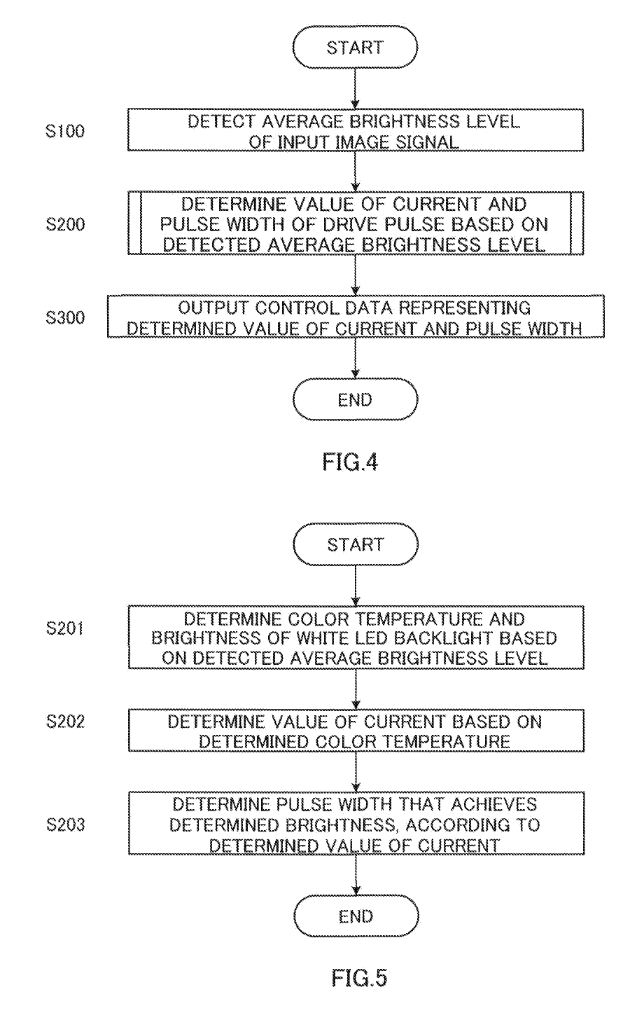

FIG. 4 is a flowchart showing an example of an LED drive pulse control in liquid crystal display apparatus 100.

First, in step S100, signal brightness level detecting section 105 acquires an image signal inputted in the liquid crystal driving section (not shown) in liquid crystal panel 101, and detects the average brightness level (APL) of the acquired image signal.

Then, in step S200, control data calculating section 104 determines value of current I and pulse width t_{ON} of drive pulse 110 based on the average brightness level detected in step S100. Details will be described later.

Then, in step S300, control data calculating section 104 generates control data representing value of current I and pulse width t_{ON} determined in step S200, and outputs the generated control data to white LED driving section 103.

Accordingly, white LED driving section 103 generates drive pulse 110 having value of current I and pulse width t_{ON}, according to the inputted control data.

By controlling value of current I and duty cycle D of drive pulse 110 in this way, it is possible to control the color temperature and brightness of white LED backlight 102 flexibly and at the same time.

Here, processing in above step S200 will be explained more in detail using FIG. 5.

In step S201, control data calculating section 104 determines the color temperature and brightness of white LED backlight 102 based on the average brightness level. The color temperature of white LED backlight 102 is determined such that the color temperature is higher when the average brightness level is higher and the color temperature is lower when the average brightness level is lower.

Then, in step S202, control data calculating section 104 determines value of current I of drive pulse 110 based on the color temperature determined in step S201.

For example, in the case where the fluorescent material in white LED 106 is a YAG (yttrium aluminum garnet) fluorescent material, value of current I is determined such that value of current I is higher when the determined color temperature of white LED backlight 102 is higher and value of current I is lower when the determined color temperature of white LED backlight 102 is lower.

Then, in step S203, control data calculating section 104 determines pulse width t_{ON} of drive pulse 110 according to value of current I determined in step S202 such that the brightness of white LED backlight 102 determined in step S201 is possible.

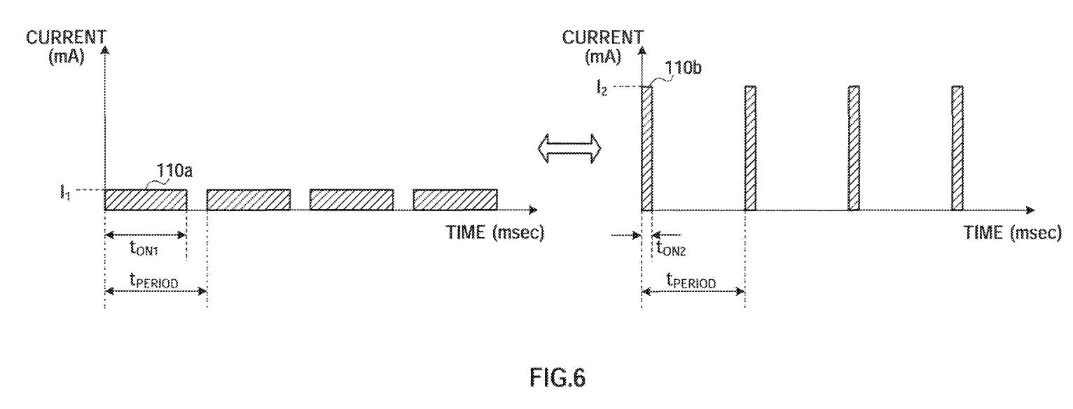

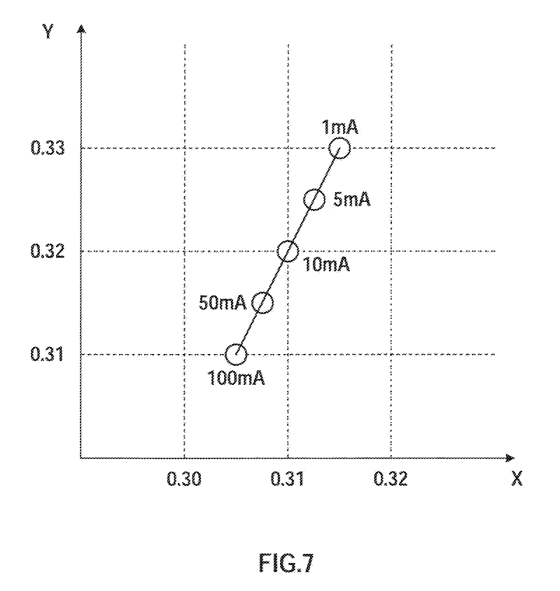

FIG. 6 shows an example of the drive pulse for which the value of current and duty cycle are changed by the LED drive pulse control.

Drive pulse 110a has value of current I₁ and has pulse width t_{ON1} determined according to this value of current I₁. Drive pulse 110b has value of current I₂ and has pulse width t_{ON2} determined according to this value of current I₂. Value of current I₂ is higher than value of current I₁. Further, pulse width t_{ON2} is narrower than pulse width t_{ON1} , so that the duty cycle (t_{ON2}/t_{PERIOD}) of drive pulse 110b is lower than the duty cycle (t_{ON1} /t_{PERIOD}) of drive pulse 110a.

Here, the brightness of white LED backlight 102 is determined based on the product of value of current I and pulse width t_{ON} of drive pulse 110. Consequently, when control data calculating section 104 maintains the brightness of white LED backlight 102 constant and changes the color temperature of white LED backlight 102, pulse width t_{ON} is determined such that pulse width t_{ON} is narrower when value of current I is greater and pulse width t_{ON} is wider when value of current I is smaller.

To be more specific, as shown in FIG. 6, when value of current I is increased from I₁ to I₂ (for example, when the value of current I is increased—“ten times”), pulse width t_{ON} is reduced from t_{ON1} to t_{ON2} (for example, the of pulse width t_{ON} is decreased—“one tenth”). Alternatively, when value of current I decreases from I₂ to I₁ (for example, value of current I is decreased—“one tenth”), pulse width t_{ON} is increased from t_{ON2} to t_{ON1} (for example, pulse width t_{ON} is decreased—“ten times”). In any case, it is possible to maintain the brightness of white LED backlight 102 constant and change the color temperature of white LED backlight 102.

Next, the relationship between the fluorescent material in white LED 106 and the color temperature control in white LED backlight 102 will be explained.

In the case where a fluorescent material is a YAG fluorescent material, white LED 106 has a characteristic of, as shown in FIG. 7, lowering the color temperature when value of current I of drive pulse 110 becomes lower (that is, the chromaticity point approaches the area of red color), and increasing the color temperature when value of current I of drive pulse 100 becomes higher (that is, the chromaticity point approaches the area of blue color).

Consequently, assume that white LED 106 has a YAG fluorescent material, when the average brightness level of an input image signal is low, a control to decrease value of current I is performed to lower the color temperature of white LED backlight 102. Further, when the average brightness level of an input image signal is high, a control to increase value of current I is performed to increase the color temperature of white LED backlight 102.

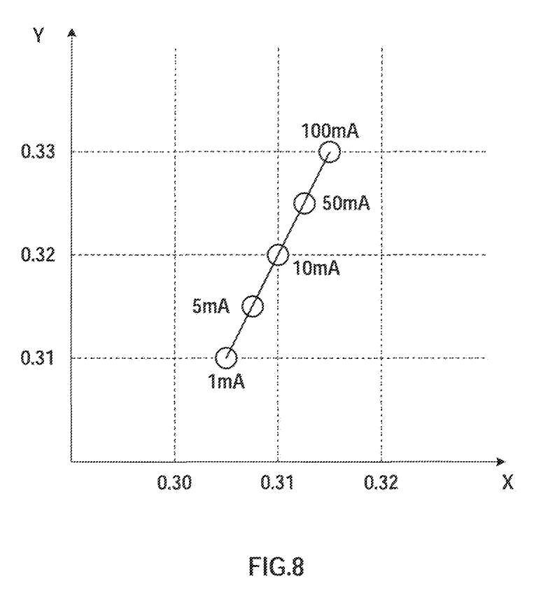

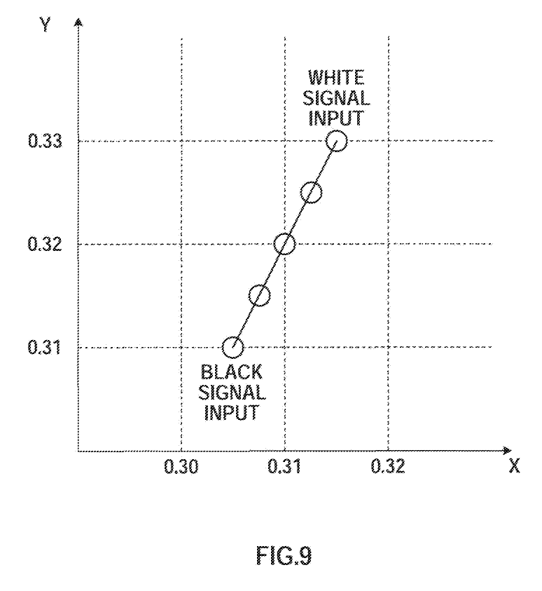

Further, in the case where the fluorescent material is a silicate fluorescent material (for example, Eu2+activated alkaline earth metal orthosilicate), white LED 106 has a characteristic of, as shown in FIG. 8, decreasing the color temperature when current I of drive pulse 110 becomes higher (that is, the chromaticity point approaches the area of red color), and increasing the color temperature when value of current I of drive pulse 110 becomes lower (that is, the chromaticity point approaches the area of blue color).

Consequently, assume that white LED 106 has a silicate fluorescent material, when the average brightness level of an input image signal is low, a control to increase value of current I is performed to lower the color temperature of white LED backlight 102. Further, when the average brightness level of an input image signal is high, a control to decrease value of current I is performed to increase the color temperature of white LED backlight 102.

Even if the fluorescent material is of any type, the color temperature of white LED backlight 102 is changed when drive pulse 110 is controlled as described above, so that it is possible to alleviate or ideally cancel a phenomenon that is caused by the nature of liquid crystal panel 101. Here, the phenomenon that is caused by the nature of liquid crystal panel 101 means the phenomenon where, as shown in FIG. 9, the color temperature becomes higher when the brightness level of an image signal becomes lower and the color temperature becomes lower when the brightness level of an image signal becomes higher. Consequently, when the brightness level of an image signal is high, white that shines bluish can be displayed on the display screen, and, when the brightness level of an image signal is low, black color with a suppressed bluish tinge can be displayed on the display screen.

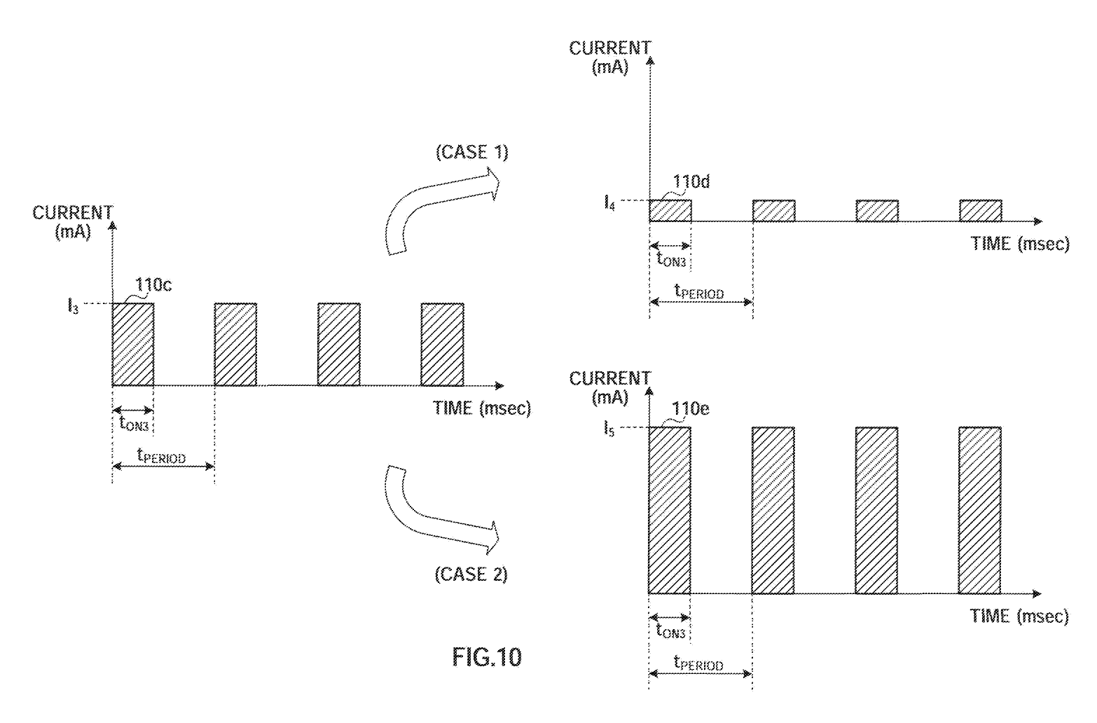

FIG. 10 shows an example of drive pulses for which only values of current are changed by the LED drive pulse control.

First, case 1 is assumed where the average brightness level lowers while drive pulse 110c is generated. In this case, control data calculating section 104 decreases the value of current from I₃ to I₄ according to the average brightness level that has lowered, and outputs control data representing value of current I₄ and pulse width t_{ON3}, to white LED driving section 103. Then, white LED driving section 103 generates drive pulse 110d according to the control data.

By this means, it is possible to lower the brightness of white LED backlight 102. Further, in the case where white LED 106 has a YAG fluorescent material, it is possible to lower the color temperature of white LED backlight 102 and improve a bluish tinge in black color. Further, it is possible to lower the color temperature of white LED backlight 102 and improve a bluish tinge in black color at the same time only by changing value of current I of drive pulse 110.

Further, in the case where white LED 106 has a silicate fluorescent material, the color temperature of white LED backlight 102 rises. Consequently, in the case where white LED 106 has a silicate fluorescent material, the color temperature can be lowered while the brightness is lowered, by raising value of current I and decreasing the duty cycle at a proportion greater than the proportion value of current I rises.

Next, case 2 is assumed where the average brightness level rises while drive pulse 110c is generated. In this case, control data calculating section 104 increases the value of current from I₃ to I₅ according to the average brightness level that has risen, and outputs control data representing value of current I₅ and pulse width t_{ON3}, to white LED driving section 103. Then, white LED driving section 103 generates drive pulse 110e according to the control data.

By this means, it is possible to raise the brightness of white LED backlight 102. Further, in the case where white LED 106 has a YAG fluorescent material, it is possible to raise the color temperature of white LED backlight 102 and suppress the decrease in the brightness of white. Further, it is possible to raise the color temperature of white LED backlight 102 and suppress the decrease in the brightness of white at the same time only by changing value of current I drive pulse 110.

Further, in the case where white LED 106 has a silicate fluorescent material, the color temperature of white LED backlight 102 lowers. Consequently, in the case where white LED 106 has a silicate fluorescent material, the color temperature can be raised while the brightness is raised, by lowering value of current I and increasing the duty cycle at a proportion greater than the proportion value of current I decreases.

As described above, the present embodiment changes the color temperature of a white LED backlight by increasing or decreasing the value of current of a drive pulse for white LED's. By this means, in the case where the light source is a white LED backlight, it is possible to change the color temperature of a display image by performing a drive control of the light source.

Generally, a white LED backlight differs from a fluorescent tube in controlling the color temperature by performing a drive control of the white LED backlight. However, when the influence upon display images is taken into account, changing the color temperature of a backlight is not necessarily preferable. Therefore, in liquid crystal display apparatuses having white LED backlights, generally, only the duty cycle of the drive pulse is changed to change the brightness of the backlight and the value of current of the drive pulse is fixed or controlled not to change the color temperature of the backlight. By contrast with this, the present embodiment overturns common knowledge about the drive control of white LED backlights, and actively changes the value of current of the drive pulse. Consequently, it naturally follows that, like conventional art, the present embodiment can control the brightness of the light source and, further, provides a distinct advantage of executing a brightness control and a color temperature control that is effective to, for example, correct the bluish tinge in black color in display images.

Further, in the case where white LED backlight 102 is a direct type backlight device, an LED drive pulse control according to the present embodiment would be more effective by grouping multiple aligned white LED's 106 into groups on a per area basis and performing this LED drive pulse control of each group of white LED's 106. For example, at the same time, a control of applying drive pulses 110d shown in FIG. 10 to groups of white LED's 106 belonging to a certain area and a control of applying drive pulses 110e shown in FIG. 10 to groups of white LED's 106 belonging to other areas, are performed. By this means, it is possible to perform a brightness control and a color temperature control on a per area basis.

### Embodiment 2

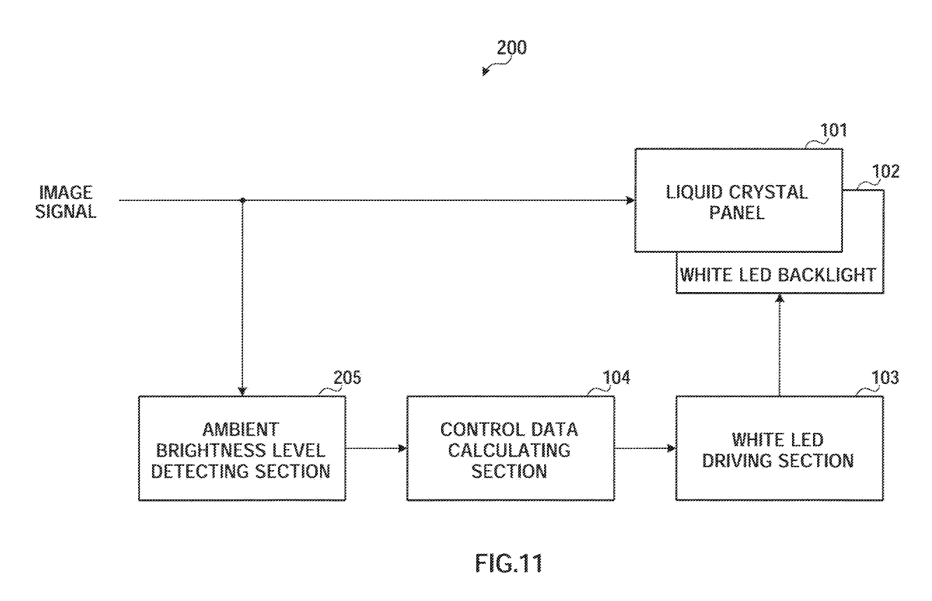

FIG. 11 is a block diagram showing a configuration of the liquid crystal display apparatus according to Embodiment 2 of the present invention. In liquid crystal display apparatus 200 shown in FIG. 11, the same components as in liquid crystal display apparatus 100 shown in FIG. 1 will be assigned the same reference numerals and explanation thereof will be omitted.

Liquid crystal display apparatus 200 differs from liquid crystal display apparatus 100 in the configuration where signal brightness level detecting section 105 is not provided and ambient brightness level detecting section 205 is provided instead.

Ambient brightness level detecting section 205 is a sensor that detects, as the amount of characteristic of ambient light, the brightness level of ambient light in the environment where liquid crystal display apparatus 200 is installed.

While an LED drive pulse control is performed based on the amount of characteristic of an image signal with Embodiment 1, an LED drive pulse control is performed based on the amount of characteristic of ambient light with the present embodiment. The rest of details of the present embodiment are the same as in Embodiment 1 and detailed explanation thereof will be omitted.

As described above, an LED drive pulse control is performed based on the amount of characteristic of ambient light according to the present embodiment. Although, for example, when the brightness level of ambient light is low, the bluish tinge in black color becomes more distinct, an LED drive pulse control to lower the color temperature of white LED backlight 102 is performed with the present embodiment. Further, when the brightness level of ambient light is high, an LED drive pulse control to raise the color temperature of white LED backlight 102 is performed. Consequently, with the present embodiment, when the brightness level of ambient light is high, white that shines bluish can be displayed on the display screen and, when the brightness level of ambient light is low, black color with a suppressed bluish tinge can be displayed on the display screen.

Moreover, it is possible to appropriately combine the configuration of liquid crystal display apparatus 100 of Embodiment 1 with the configuration of liquid crystal display apparatus 200.

Embodiments of the present invention have been explained so far.

Further, the above explanation is an illustration of preferred embodiments of the present invention and the scope of the present invention is not limited to this. That is, the configuration of the above apparatus and the operation upon use of the above apparatus have been explained as examples, and it is obvious that various modifications and additions are possible within the scope of the present invention.

### INDUSTRIAL APPLICABILITY

The liquid crystal display apparatus according to the present invention can be utilized as a liquid crystal display apparatus for liquid crystal televisions, liquid crystal monitors and so on.

### REFERENCE SIGNS LIST

100, 200 LIQUID CRYSTAL DISPLAY APPARATUS
101 LIQUID CRYSTAL PANEL
102 WHITE LED BACKLIGHT
130 WHITE LED DRIVING SECTION
104 CONTROL DATA CALCULATING SECTION
105 SIGNAL BRIGHTNESS LEVEL DETECTING SECTION
205 AMBIENT BRIGHTNESS LEVEL DETECTING SECTION

1. A liquid crystal display apparatus comprising:
a liquid crystal panel that displays an image;
a backlight that comprises a white light emitting diode and illuminates the liquid crystal panel;
a generating section that generates a drive pulse for the white light emitting diode; and
a controlling section that controls a color temperature of the backlight by increasing or decreasing a value of current of the drive pulse that is generated,
wherein the controlling section determines a duty cycle of the drive pulse that is generated, according to the value of current that is increased or decreased.

2. The liquid crystal display apparatus according to claim 1, wherein the controlling section decreases the duty cycle to maintain a brightness of the backlight constant when the value of current is increased, and increases the duty cycle to maintain the brightness of the backlight constant when the value of current is decreased.

3. The liquid crystal display apparatus according to claim 1, wherein:
the white light emitting diode comprises a yttrium aluminum garnet fluorescent material;
the backlight illuminates the liquid crystal panel with light that is whitened through an action of the yttrium aluminum garnet fluorescent material; and
the controlling section raises the color temperature of the backlight by increasing the value of current, and lowers the color temperature of the backlight by decreasing the value of current.

4. The liquid crystal display apparatus according to claim 1, wherein:
the white light emitting diode comprises a silicate fluorescent material;
the backlight illuminates the liquid crystal panel with light that is whitened through an action of the silicate fluorescent material; and
the controlling section lowers the color temperature of the backlight by increasing the value of current, and raises the color temperature of the backlight by decreasing the value of current.

5. A liquid crystal display apparatus comprising:
a liquid crystal panel that displays an image based on an image signal;
a backlight that comprises a white light emitting diode and illuminates the liquid crystal panel;
a generating section that generates a drive pulse for the white light emitting diode;
a detecting section that detects one of the amount of characteristic of the image signal and the amount of characteristic of ambient light; and
a controlling section that controls a color temperature of the backlight by increasing or decreasing a value of current of the drive pulse that is generated, according to the amount of characteristic detected.

6. The liquid crystal display apparatus according to claim 5, wherein the controlling section determines a duty cycle of the drive pulse that is generated, according to the value of current that is increased or decreased.

7. The liquid crystal display apparatus according to claim 5, wherein:
the white light emitting diode comprises a yttrium aluminum garnet fluorescent material;
the backlight illuminates the liquid crystal panel with light that is whitened through an action of the yttrium aluminum garnet fluorescent material; and
the controlling section raises the color temperature of the backlight by increasing the value of current, and lowers the color temperature of the backlight by decreasing the value of current.

8. The liquid crystal display apparatus according to claim 5, wherein:
the white light emitting diode comprises a silicate fluorescent material;
the backlight illuminates the liquid crystal panel with light that is whitened through an action of the silicate fluorescent material; and
the controlling section lowers the color temperature of the backlight by increasing the value of current, and raises the color temperature of the backlight by decreasing the value of current.
